(19) United States
(12) Patent Application Publication
(10) Pub. No.: US 2026/0106694 A1
(43) Pub. Date: Apr. 16, 2026

(54) WIRELESS COMMUNICATION DEVICE AND PACKET RECEPTION CONTROL METHOD THEREOF

(71) Applicant: Realtek Semiconductor Corporation, Hsinchu (TW)

(72) Inventor: Cheng Feng LIN, Hsinchu (TW)

(21) Appl. No.: 19/340,883

(22) Filed: Sep. 26, 2025

(30) Foreign Application Priority Data
Oct. 14, 2024 (TW) 113139039

(51) Int. Cl. H04L 1/00; H04L 69/22

(52) U.S. Cl. CPC H04L 1/0072; H04L 1/0045; H04L 69/22

(57) ABSTRACT

A wireless communication device including: a radio frequency (RF) circuit, a baseband circuit, and a media access control (MAC) circuit. The RF circuit is configured to receive a packet transmitted from an access point to generate an RF signal and convert the RF signal into a baseband signal. The baseband circuit is coupled to the RF circuit, and configured to decode the baseband signal to obtain bit data. The MAC circuit is coupled to the baseband circuit, and configured to parse the bit data to obtain information of a specific field in the packet, and stop receiving the packet in response to determining that the information of the specific field does not match the wireless communication device.

### RELATED APPLICATIONS

This application claims priority to Taiwan Application Serial Number 113139039, field October 14, 2024, which is herein incorporated by reference.

### BACKGROUND

### Technical Field

The present disclosure relates to packet reception, and more particularly to a wireless communication device and a packet reception control method thereof.

### Description of Related Art

In a Wi-Fi system, a station (STA) is usually a wireless communication device such as a smart phone, a tablet, and a wearable device. For a STA that is primarily powered by internal batteries, power consumption is one of the main considerations for its performance. However, if the STA frequently receives packets irrelevant thereto, e.g., packets not belonging thereto, or packets with contents not required therefor, the unnecessary power consumption of the STA significantly increases.

### SUMMARY

One aspect of the present disclosure directs to a wireless communication device including a radio frequency (RF) circuit, a baseband circuit, and a media access control (MAC) circuit. The RF circuit is configured to receive a packet transmitted from an access point to generate an RF signal and convert the RF signal into a baseband signal. The baseband circuit is coupled to the RF circuit, and configured to decode the baseband signal to obtain bit data. The MAC circuit is coupled to the baseband circuit, and configured to parse the bit data to obtain information of a specific field in the packet, and stop receiving the packet in response to determining that the information of the specific field does not match the wireless communication device.

Another aspect of the present disclosure directs to a packet reception control method performed by a wireless communication device, the packet reception control method including: performing address search on a packet to obtain a destination media access control (MAC) address of a MAC header in the packet at a start of receiving the packet transmitted from an access point; determining whether the destination MAC address matches the wireless communication device; and resetting a receiving function of a baseband circuit of the wireless communication device to stop receiving the packet in response to determining that the destination MAC address does not match the wireless communication device.

Yet another aspect of the present disclosure directs to a packet reception control method performed by a wireless communication device, the packet reception control method including: parsing a beacon frame to obtain information of a specific field in the beacon frame at a start of receiving the beacon frame transmitted from an access point; determining whether the information matches the wireless communication device; and turning off a radio frequency (RF) circuit of the wireless communication device to stop receiving the beacon frame in response to determining that the information of the specific field does not match the wireless communication device.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2 is a schematic block diagram of a wireless communication device in accordance with some embodiments of the present disclosure.

FIG. 3 is a flowchart of a packet reception control method in accordance with some embodiments of the present disclosure.

FIG. 4 is a flowchart of a packet reception control method in accordance with other embodiments of the present disclosure.

FIG. 5 is a timing diagram of a station and an access point according to an example.

FIG. 6 is a timing diagram of a station and an access point according to another example.

FIG. 7 is a timing diagram of a station and an access point according to yet another example.

### DETAILED DESCRIPTION

The detailed explanation of the present disclosure is described as following. The described preferred embodiments are presented for purposes of illustrations and description, and they are not intended to limit the scope of the present disclosure.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, High Efficiency (HE) modes, and Extremely High Throughput (EHT) modes. The HT modes, the VHT modes, the HE modes, and the EHT modes correspond to standards of wireless local area networks of various communication generations such as Wi-Fi 4, Wi-Fi 5, Wi-Fi 6, and Wi-Fi 7, respectively. More transmission modes are usable for a wireless communication device if the hardware specification thereof is better and the Wi-Fi system supported thereby is more advanced. The embodiments of the present disclosure also support other wired and/or wireless communication technologies such as cellular network, Bluetooth, local area network (LAN) and/or Universal Serial Bus (USB).

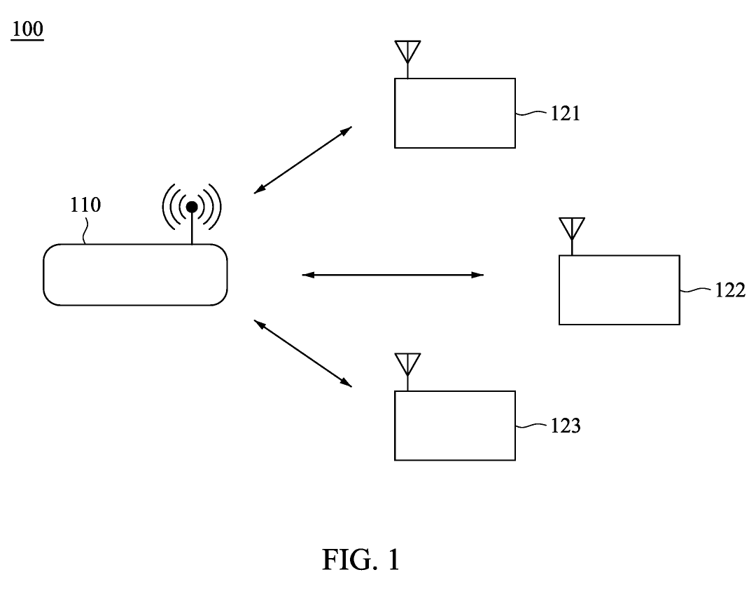

FIG. 1 is a schematic diagram of a wireless communication system 100 in accordance with some embodiments of the present disclosure. The wireless communication system 100 includes a wireless access point (AP) device (also referred to as “AP”) 110 and wireless station (STA) devices (also referred to as “STA”) 121-123. The wireless AP device 110 provides the wireless access service within a certain range, and each of the wireless STA devices 121-123 may establish wireless communication connections with the wireless AP device 110 to access the local area network and/or wide area network (for example, Internet) via Wi-Fi channels (e.g., IEEE 802.11 channel). The wireless communication connection between the wireless AP device 110 and any of the wireless STA devices 121-123 may include, but not limited to, registration procedures, identity and access management procedures, establishment and release of wireless connections, transmission and/or reception of control signals, and/or transmission and/or reception of data signal. Each of the wireless STA devices 121-123 may be, for example, a smart phone, a tablet, a laptop, or other devices with wireless signal transmission and reception function. Additionally, the wireless AP device 110 may be, for example, a wireless router, a wireless switch, or a device with AP function. In other embodiments, the wireless STA devices 121-123 may also have wireless AP function. It should be understood that the number of the wireless STA devices is not limited to that shown in FIG. 1.

The wireless communication system 100 may support the orthogonal frequency division multiple access technology. In the wireless communication system 100, the wireless AP device 110 may divide the wireless channel resource with specific bandwidth into multiple resource units, and allocate the corresponding resource units to the wireless STA devices 121-123 so that the frequency bands used by the wireless STA devices 121-123 for transmitting and receiving signals at the same time do not overlap with each other. Furthermore, the wireless communication system 100 may support multiple-input multiple-output (MIMO) technology, multiple-input single-output (MISO) technology, single-input multiple-output (SIMO) technology, and/or single-input single-output (SISO) technology.

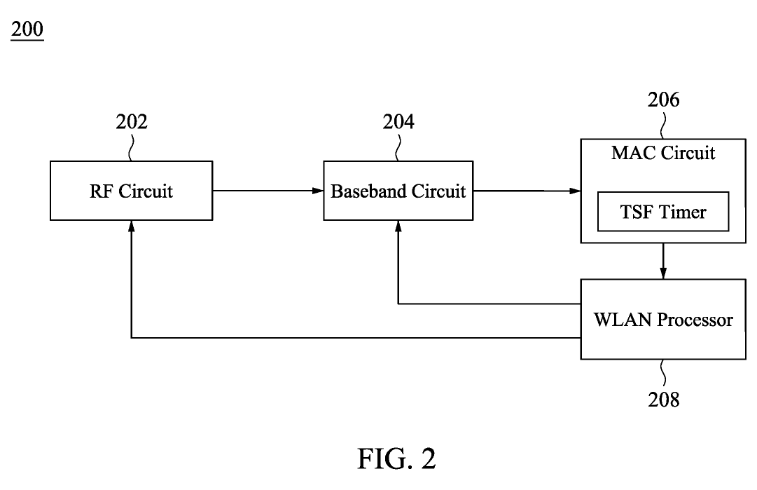

FIG. 2 is a schematic block diagram of a wireless communication device 200 in accordance with some embodiments of the present disclosure. The wireless communication device 200 supports Wi-Fi transmissions, and may be, for example, any one of the wireless STA devices 121-123 in the wireless communication system 100 or other STAs supporting Wi-Fi transmission technology.

As shown in FIG. 2, the wireless communication device 200 includes a radio frequency (RF) circuit 202, a baseband circuit 204, a media access control (MAC) circuit 206, and a wireless local area network (WLAN) processor 208. The RF circuit 202 is configured to receive a packet to generate a radio frequency signal, and convert the radio frequency signal to a baseband signal. In this disclosure, the packets and beacon frame (may be considered as a kind of packet) sent by the AP are received by the radio frequency circuit 202 in the form of electromagnetic waves to generate the radio signals, and the radio frequency signals are converted into the baseband signals with frequency reduction by the radio frequency circuit 202. The baseband circuit 204 is coupled to the radio frequency circuit 202, and configured to decode the baseband signal to obtain bit data. The MAC circuit 206 is coupled to the baseband circuit 204, and configured to parse the bit data to obtain the information of each field in the packet and/or beacon frame received by the wireless communication device 200. The MAC circuit 206 may include timing synchronization function (TSF) timer 206A (also referred to as “STA TSF timer”), which may perform timing synchronization with the AP according to the information of a timestamp field in the beacon frame received by the wireless communication device 200. The WLAN processor 208 is coupled to the radio frequency circuit 202, the baseband circuit 204, and the MAC circuit 206, and configured to perform corresponding operations according to the processing result of the MAC circuit 206, for example, obtaining a MAC protocol data unit (MPDU) in the packet, resetting the baseband circuit 204, and turn on/off the radio frequency circuit 202.

Particularly, the MAC circuit 206 may parse the packet at the same time when starting receiving the packet, to obtain the information of each field in the packet, and when obtaining the information of the specific field of the packet, determine whether the information of the specific field matches the wireless communication device 200. When determining that the information of the specific field does not match the wireless communication device 200, the wireless communication device 200 may stop receiving the packet immediately without receiving a complete packet, so that the power consumption of the wireless communication device 200 decreases.

Specifically, when the wireless communication device 200 starts receiving the packet, the MAC circuit 206 may perform address search (a kind of parsing) for the packet to obtain a destination MAC address of a MAC header field (that is, the information of the specific field mentioned above) in the packet from the bit data, and determine whether the destination MAC address matches the wireless communication device 200 (for example, determining whether the destination MAC address matches a MAC address of the wireless communication device 200). When determining that the destination MAC address does not match the wireless communication device 200 (for example, the destination MAC address does not match a MAC address of the wireless communication device), the MAC circuit 206 may send a reset signal to the baseband circuit 204, so that the baseband circuit 204 resets its receiving function according to the reset signal to stop receiving the current packet and prepare to receive the next packet.

Additionally, when the wireless communication device 200 starts receiving the beacon frame (the packet mentioned above), the MAC circuit 206 may parse the beacon frame to obtain the information of the specific field in the beacon frame, and determine whether the information of the specific field matches the wireless communication device 200. The field in the beacon frame is also referred to as information element (IE). The specific field may be a mandatory field or an optional field located in the frame body of the beacon frame such as a timestamp field, a beacon interval field, a direct sequence parameter set field, a traffic indication map (TIM) field, or may be a combination of one or a plurality of mandatory field and/or one or a plurality of optional field. When determining that the information of the specific field does not match the wireless communication device 200, the MAC circuit 206 sends a trigger signal to the WLAN processor 208, so that the WLAN processor 208 sends a turn-off signal to the radio frequency circuit 202 according to the trigger signal to turn off the radio frequency circuit 202 to stop receiving the current beacon frame, thereby decreasing the power consumption of the wireless communication device 200. For example, the specific field may be a TIM field, and when the MAC circuit 206 determines that the information in the TIM field does not match the wireless communication device 200 (for example, the value of the TIM field is equal to 0, which represents that the AP has no temporarily stored data to be transmitted to the wireless communication device 200), it sends the trigger signal to the WLAN processor 208, so that the WLAN processor 208 sends the turn-off signal to the radio frequency circuit 202 according to the trigger signal to turn off the radio frequency circuit 202, so as to stop receiving all fields after the TIM field in the beacon frame.

In some embodiments, when determining the information of the specific field does not match the wireless communication device 200, the WLAN processor 208 further sends the reset signal to the baseband circuit 204 according to the trigger signal to reset the baseband circuit 204 to further decrease the power consumption of the wireless communication device 200.

In the embodiment that the specific field is located after the timestamp field, even if it is determined that the information of the specific field does not match the wireless communication device 200, as the MAC circuit 206 has obtained the information in the timestamp field of the beacon frame, the MAC circuit 206 may still perform timing synchronization on the TSF timer 206A with the AP by using the information in the timestamp field. Alternatively, the MAC circuit 206 may calculate the TSF timer of the AP (also referred to as “AP TSF timer”) according to the information of the timestamp field, and when determining that the difference between the AP TSF timer and its TSF timer 206A is smaller than a preset threshold value, perform timing synchronization on its TSF timer 206A with the AP by using the information of the timestamp field. In this way, it may avoid the TSF timer 206A from being synchronized to an incorrect time.

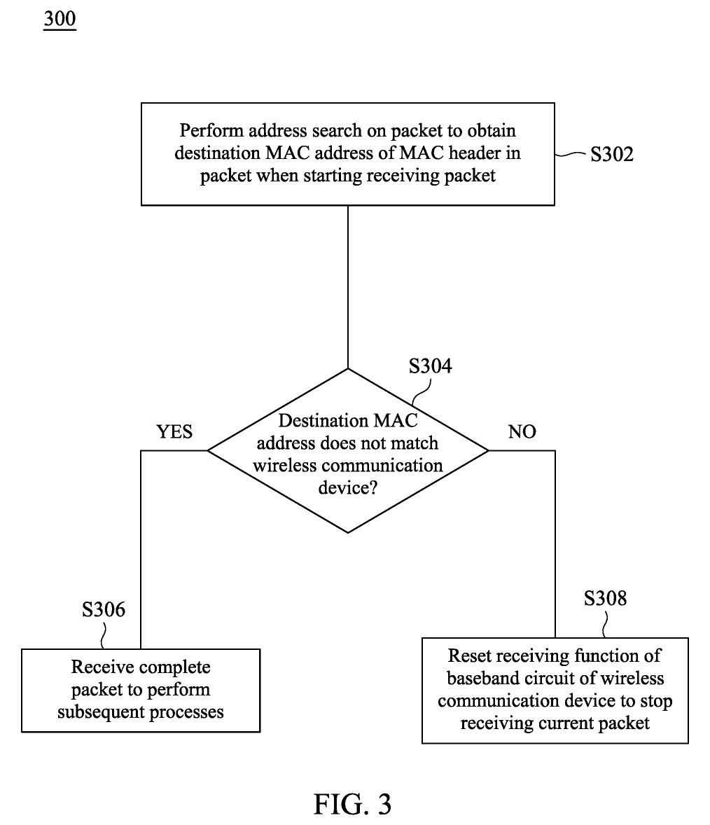

FIG. 3 is a flowchart of a packet reception control method 300 in accordance with some embodiments of the present disclosure. The packet reception control method 300 is adapted to the wireless communication device supporting Wi-Fi transmission technology, such as the wireless communication device 200 of FIG. 2 and other wireless communication devices with similar architectures (that is, with circuit functions such as the radio frequency circuit 202, the baseband circuit 204, the MAC circuit 206, and the WLAN processor 208).

The packet reception control method 300 is performed by the wireless communication device and includes the following operations. First, when starting receiving the packet transmitted by the AP, Operation S302 is performed to perform address search for the packet to obtain the destination MAC address of the MAC header in the packet. Next, Operation S304 is performed to determine whether the destination MAC address matches the wireless communication device (for example, determine whether the destination MAC address matches the MAC address of the wireless communication device). When determining that the destination MAC address matches the wireless communication device, Operation S306 is performed to receive the complete packet to perform subsequent processes, for example, extract a MAC protocol data unit from the packet to the WLAN processor of the wireless communication device and/or other higher-level circuits. On the contrary, when determining that the destination MAC address does not match the wireless communication device (for example, the destination MAC address does not match the MAC address of the wireless communication device), in Operation S308, the receiving function of the baseband circuit of the wireless communication device is reset to stop receiving the current packet and prepare to receive the next packet.

By performing the packet reception control method 300, when determining that the destination MAC address does not match the wireless communication device during packet reception, this packet may be immediately stopped from being received and a new packet is started to be received, rather than waiting until a complete packet is received before discarding this packet and starting to receive the new packet, so that the unnecessary power consumption of the wireless communication device under the power saving mode may effectively decreased.

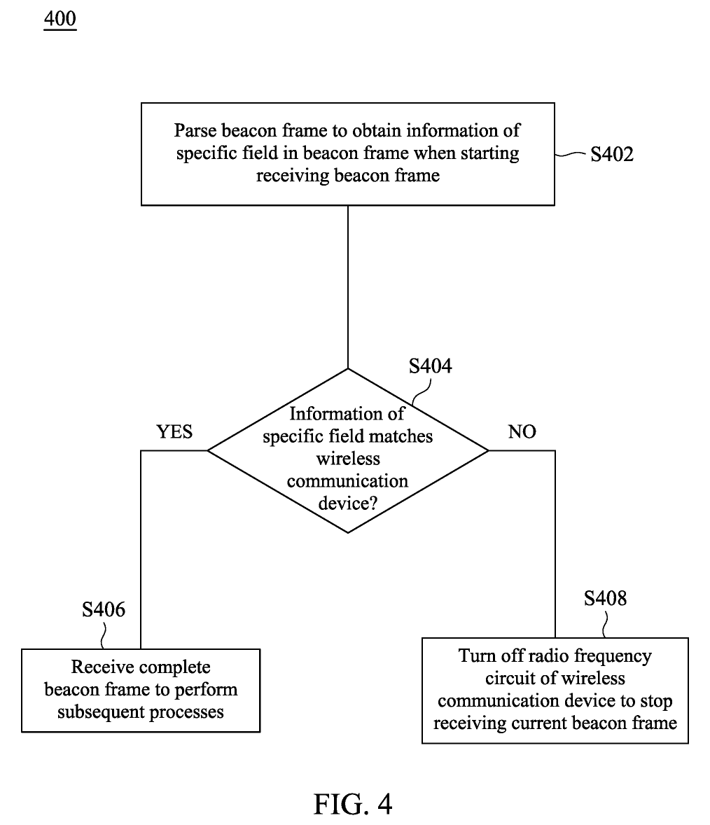

FIG. 4 is a flowchart of a packet reception control method 400 in accordance with other embodiments of the present disclosure. Similarly, the packet reception control method 400 is adapted to, for example, the wireless communication device 200 in FIG. 2, and other wireless communication devices with similar architectures.

The packet reception control method 400 is performed by a wireless communication device and includes the following operations. First, when starting receiving the beacon frame transmitted from the AP, Operation S402 is performed to parse the beacon frame to obtain the information of the specific field in the beacon frame. The specific field may be a mandatory field or an optional field located in a frame body of the beacon frame, for example, a timestamp field, a beacon interval field, a direct sequence parameter set field, a TIM field. Next, Operation S404 is performed to determine whether the information of the specific field matches the wireless communication device. When determining that the information of the specific field matches the wireless communication device, Operation S406 is performed to receive the complete beacon frame to perform subsequence processes, such as parsing the information of each field in the beacon frame and confirming whether the information of the frame check sequence (FCS) field is correct. On the contrary, when determining that the information of the specific field does not match the wireless communication device, Operation S408 is performed to turn off the radio frequency circuit of the wireless communication device to stop receiving the current beacon frame, thereby decreasing the power consumption of the wireless communication device. In some embodiments, Operation S408 further includes resetting the receiving function of the baseband circuit of the wireless communication device to further decrease the consumption of the wireless communication device.

Especially, in the embodiment that the specific field is located after the timestamp field, even if it is determined that the information of the specific field does not match the wireless communication device, as the information of the timestamp field in the beacon frame has been obtained, the wireless communication device may still perform timing synchronization on its TSF timer with APs by using the information of the timestamp field. Alternatively, the wireless communication device may calculate the TSF timer of the AP according to the information of the timestamp field first and compare the TSF timer of the AP with its TSF timer, and when determining that the difference between the AP TSF timer and its TSF timer is smaller than a preset threshold value, timing synchronization is performed on its TSF timer with the AP by using the information of the timestamp field.

In the subsequent description of the timing diagram, the STA may be the wireless communication device 200 and be used for performing the packet reception control method 400, and the AP transmits the beacon frame every 100 time unit (hereinafter referred to as “TU”) with taking the TIM field as an example for the specific field.

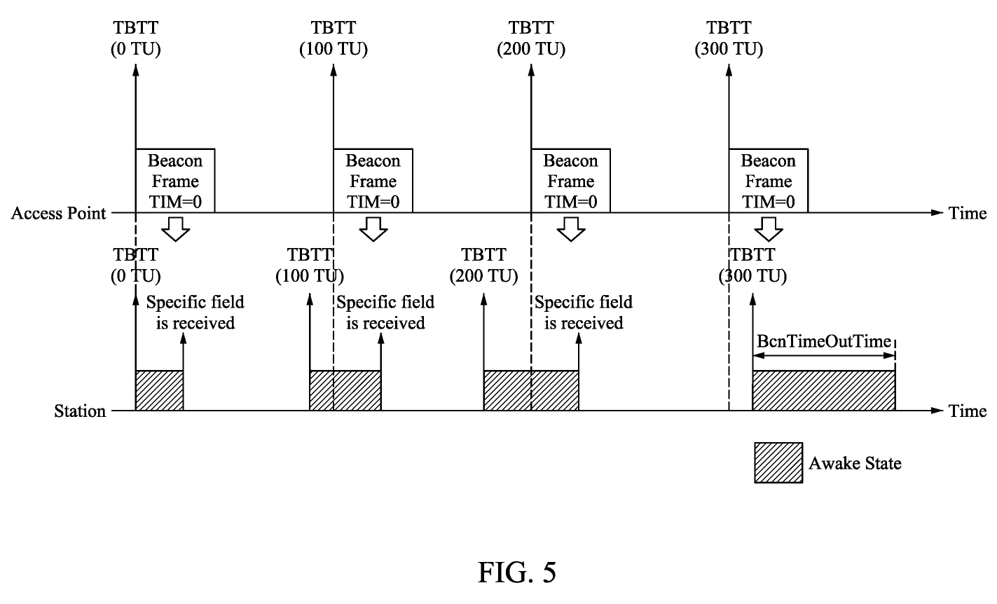

FIG. 5 is a timing diagram of a STA and an AP according to an example. In the example of FIG. 5, when determining that the information of the TIM field in the beacon frame does not match (TIM=0, which represents that the AP has no temporarily stored data to be transmitted to the STA), the STA enters the doze state and does not update the TSF timer.

The timing diagram of FIG. 5 is described as follows. At the first target beacon transmission time (hereinafter referred to as “TBTT”) of the AP, the TSF timer of the AP is 0TU, and as the AP and the STA are synchronized, the first TBTT of the STA (the TSF timer of the STA is 0) is also aligned with the first TBTT of the AP due to synchronization. That is, when the access starts transmitting the beacon frame, the STA enters an awake state simultaneously to start receiving the beacon frame. When receiving the TIM field of the beacon frame and determining that the value of the TIM field is equal to 0 (TIM=0), the STA enters the doze state (for example, turning off its radio frequency circuit and resetting its baseband circuit). As the STA has not received the FCS field of the beacon frame (due to stopping receiving the content after the TIM field), it does not synchronize its TSF timer with the AP.

Then, at the second TBTT of the AP (at this time, the TSF timer of the AP is 100TU), as the STA does not synchronize its TSF timer with the AP during the previous beacon frame reception, there is an error in the TSF timers of the STA with the AP. In the example of FIG. 5, the TSF timer of the STA reaches 100TU earlier than the TSF timer of the AP (that is, the second TBTT of the STA precedes the second TBTT of the AP), so the STA enters the awake state before the AP starts transmitting the beacon frame. Also, as the STA enters the awake state earlier and starts receiving the beacon frame until the second TBTT of the AP, the power consumption for the STA to receive the beacon frame increases (the power consumption between the second TBTT of the STA and the AP increases). When receiving the TIM field of the beacon frame and determining that the value of the TIM field is equal to 0 (TIM=0), the STA enters the doze state again.

Then, at the third TBTT of the AP (at this time, the TSF timer of the AP is 200 TU), as the STA still has not synchronized its TSF timer with the AP during the previous beacon frame reception, there is an error in the TSF timers of the STA with the AP. In the example of FIG. 5, the TSF timer of the STA reaches 200TU earlier than the TSF timer of the AP (that is, the third TBTT of the STA precedes the third TBTT of the AP), so the STA has entered the awake state before the AP starts transmitting the beacon frame. Also, as the STA enters the awake state earlier during the current beacon frame reception (the time difference between the third TBTT of the STA and the AP is greater than the time difference between the second TBTT of the STA and the AP), the power consumption for the STA to receive the beacon frame further increases. When receiving the TIM field of the beacon frame and determining that the value of the TIM field is equal to 0 (TIM=0), the STA enters the doze state again.

At the fourth TBTT of the AP (at this time, the TSF timer of the AP is 300 TU), as the STA still has not synchronized its TSF timer with the AP during the previous beacon frame reception, there is an error in the TSF timers of the STA with the AP. In the example of FIG. 5, since the TSF timer of the STA reaches later than the TSF timer of the AP (that is, the fourth TBTT of the STA is later than the fourth TBTT of the AP), the STA enters the awake state after the AP transmits the beacon frame, resulting in it failing to receive the beacon frame within a beacon timeout time (that is, BcnTimeOutTime in FIG. 5) and entering the doze state. As the STA enters the awake state until the beacon times out, and the beacon timeout time is greater than the time consumed for the AP to transmit the beacon frame, the power consumption of the STA significantly increases. Furthermore, due to the failure to receive the beacon frame, the STA cannot obtain the data of the timestamp and TIM field and synchronize its TSF timer with the AP.

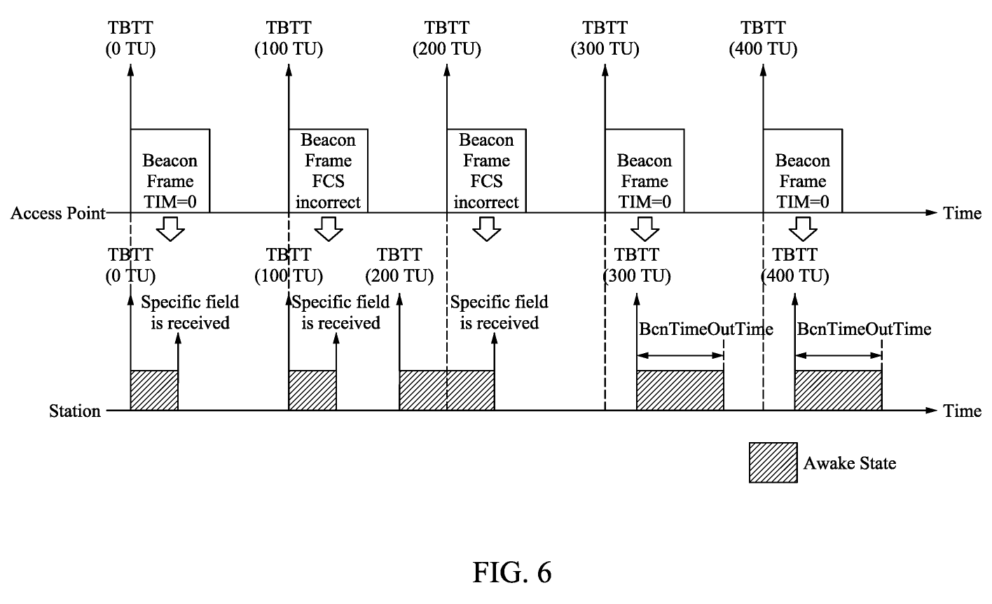

FIG. 6 is a timing diagram of a STA and an AP according to another example. In the example of FIG. 6, when determining the information of the TIM field in the beacon frame does not match (TIM=0), the STA enters the doze state and synchronizes its TSF timer according to the content of the timestamp field unconditionally.

The timing diagram of FIG. 6 is described as follows. At the first TBTT of the AP, the TSF timer of the AP is 0TU, and as the AP and the STA are synchronized, the first TBTT of the STA (the TSF timer of the STA is 0) is also aligned with the first TBTT of the AP due to synchronization. That is, when the AP starts transmitting the beacon frame, the STA enters the awake state simultaneously to start receiving the beacon frame. When receiving the TIM field of the beacon frame and determining that the value of the TIM field is equal to 0 (TIM=0, which represents that the AP has no temporarily stored data to be transmitted to the STA), the STA enters the doze state (for example, turning off its radio frequency circuit and resetting its baseband circuit). As the STA has received the timestamp field of the beacon frame (as the timestamp field is located before the TIM field), it synchronizes its TSF timer with the AP according to the information of the timestamp field.

Then, at the second TBTT of the AP (at this time, the TSF timer of the AP is 100TU), the TSF timers of the STA and the AP are roughly synchronized (due to the previous synchronization operation) and reach 100TU at the same time, so the STA enters the awake state simultaneously when the AP starts transmitting the beacon frame. When receiving the TIM field of the beacon frame and determining that the value of the TIM field is equal to 0 (TIM=0), the STA enters the doze state again. Also, as the STA has received the timestamp field of the beacon frame (as the timestamp field is located before the TIM field), it synchronizes the TSF timer with the AP according to the information of the timestamp field. However, since the STA does not continue to receive all fields (including the FCS field) after the TIM field in the beacon frame, even if the information of the timestamp field in the beacon field is incorrect, the STA still unconditionally synchronizes its TSF timer, which causes the TSF timer to be incorrect.

Then, at the third TBTT of the AP (at this time, the TSF timer of the AP is 200 TU), as the TSF timer of the STA is incorrect, there is an error in the TSF timers of the STA with the AP. In the example of FIG. 6, the TSF timer of the STA reaches 200TU earlier than the TSF timer of the AP (that is, the third TBTT of the STA precedes the third TBTT of the AP), so the STA has entered the awake state before the AP starts transmitting the beacon frame. Since the STA enters the awake state earlier and starts receiving the beacon frame until the third TBTT of the AP, the power consumption for the STA to receive the beacon frame increases (the power consumption between the third TBTT of the STA and the AP increases). When receiving the TIM field of the beacon frame and determining that the value of the TIM field is equal to 0 (TIM=0), the STA enters the doze state again. Similarly, since the STA does not continue to receive all fields (including the FCS field) after the TIM field in the beacon frame, even if the information of the timestamp field in the beacon field is incorrect, the STA still unconditionally synchronizes its TSF timer, which causes the TSF timer to be incorrect again.

At the fourth TBTT of the AP (at this time, the TSF timer of the AP is 300 TU), as the TSF timer of the STA is incorrect, there is an error in the TSF timers of the STA with the AP. In the example of FIG. 6, since the TSF timer of the STA reaches later than the TSF timer of the AP (that is, the fourth TBTT of the STA is later than the fourth TBTT of the AP), the STA enters the awake state after the AP transmits the beacon frame, resulting in it failing to receive the beacon frame within a preset time (that is, BcnTimeOutTime in FIG. 6) and entering the doze state. As the STA enters the awake state until the beacon times out, and the beacon timeout time is greater than the time consumed for the AP to transmit the beacon frame, the power consumption of the STA significantly increases. Furthermore, due to the failure to receive the beacon frame, the STA cannot obtain the data of the timestamp field and synchronize its TSF timer with the AP.

At the fifth TBTT of the AP (at this time, the TSF timer of the AP is 400 TU), as the STA does not synchronizes its TSF timer with the AP during the previous beacon frame reception, there is an error in the TSF timers of the STA with the AP. In the example of FIG. 6, since the TSF timer of the STA reaches later than the TSF timer of the AP (that is, the fifth TBTT of the STA is later than the fifth TBTT of the AP), the STA enters the awake state after the AP transmits the beacon frame, resulting in it failing to receive the beacon frame within a preset time (that is, BcnTimeOutTime in FIG. 6) and entering the doze state again. Similarly, as the STA enters the awake state until the beacon times out, and the beacon timeout time is greater than the time consumed for the AP to transmit the beacon frame, the power consumption of the STA significantly increases. Furthermore, due to the failure to receive the beacon frame, the STA cannot obtain the data of the TIM field and synchronize its TSF timer with the AP.

It is known from the description of FIG. 6, in the example that the STA unconditionally synchronizes its TSF timer according to the content of the timestamp field when determining that the information of the TIM field does not match and entering the doze state, the TSF timer of the STA might be synchronized with the incorrect value, which might cause the STA to not enter the awake state when the AP transmits the beacon frame, resulting in the inability to receive the beacon frame.

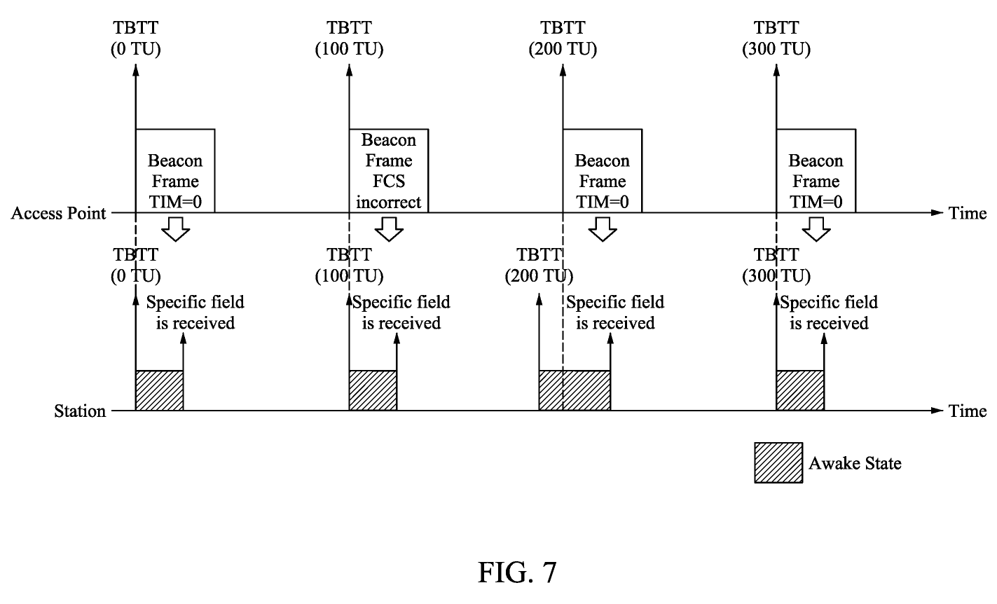

FIG. 7 is a timing diagram of a STA and an AP according to yet another example. In the example of FIG. 7, when determining that the TIM field of the beacon frame does not match (TIM=0), the STA enters the doze state, and calculates the TSF timer of the AP according to the information of the timestamp field and compares the TSF timer of the AP with its TSF timer to determine whether to synchronize its TSF timer.

The timing diagram of FIG. 7 is described as follows. At the first TBTT of the AP, the TSF timer of the AP is 0TU, and as the AP and the STA are synchronized, the first TBTT of the STA (the TSF timer of the STA is 0) is also aligned with the first TBTT of the AP due to synchronization. That is, when the AP starts transmitting the beacon frame, the STA enters the awake state simultaneously to start receiving the beacon frame. When receiving the TIM field of the beacon frame and determining that the value of the TIM field is equal to 0 (TIM=0, which represents that the AP has no temporarily stored data to be transmitted to the STA), the STA enters the doze state (for example, turning off its radio frequency circuit and resetting its baseband circuit). Since the STA has received the timestamp field of the beacon frame (as the timestamp field is located before the TIM field), it calculates the TSF timer of the AP according to the information of the timestamp field and compares the TSF timer of the AP with its TSF timer. When determining that the difference between the TSF timers of the STA and the AP is smaller than the preset threshold value, the STA synchronizes its TSF timer with the AP according to the information of the timestamp.

Then, at the second TBTT of the AP (at this time, the TSF timer of the AP is 100TU), the TSF timers of the STA and the AP are synchronized and reach 100TU at the same time, so when the AP starts transmitting the beacon frame, the STA simultaneously enters the awake state to start receiving the beacon frame. When receiving the TIM field of the beacon frame and determining that the value of the TIM field is equal to 0 (TIM=0), the STA enters the doze state again, calculates the TSF timer of the AP according to the information of the timestamp field and compares the TSF timer of the AP with its TSF timer. When determining that the difference between the TSF timers of the STA and the AP is greater than the preset threshold value, the STA determines that the information of the timestamp field is incorrect (the FCS is incorrect) and does not synchronize its TSF timer with the AP.

Then, at the third TBTT of the AP (at this time, the TSF timer of the AP is 200 TU), as the STA does not synchronize its TSF timer with the AP during the previous beacon frame reception, there is an error in the TSF timers of the STA with the AP. In the example of FIG. 7, the TSF timer of the STA reaches 200TU earlier than the TSF timer of the AP (that is, the third TBTT of the STA precedes the third TBTT of the AP), so the STA has entered the awake state before the AP starts transmitting the beacon frame. Since the STA enters the awake state earlier and starts receiving the beacon frame until the third TBTT of the AP, the power consumption for the STA to receive the beacon frame increases (the power consumption between the third TBTT of the STA and the AP increases). When receiving the TIM field of the beacon frame and determining that the value of the TIM field is equal to 0 (TIM=0), the STA enters the doze state again, calculates the TSF timer of the AP according to the information of the timestamp field, and compares the TSF timer of the AP with its TSF timer. When determining that the difference between the TSF timers of the STA and the AP is smaller than the preset threshold value, the STA synchronizes its TSF timer with the AP according to the information of the timestamp.

At the fourth TBTT of the AP (at this time, the TSF timer of the AP is 300TU), the TSF timers of the STA and the AP are synchronized and reach 300TU at the same time, so when the AP starts transmitting the beacon frame, the STA simultaneously enters the awake state to start receiving the beacon frame. When receiving the TIM field of the beacon frame and determining that the value of the TIM field is equal to 0 (TIM=0), the STA enters the doze state again, calculates the TSF timer of the AP according to the information of the timestamp field, and compares the TSF timer of the AP with its TSF timer. When determining that the difference between the TSF timers of the STA and the AP is smaller than the preset threshold value, the STA synchronizes its TSF timer with the AP according to the information of the timestamp.

It is known from the description of FIG. 7, in the example that the STA calculates the TSF timer of the AP according to the information of the timestamp field and compares the TSF timer of the AP with its TSF timer to determine whether to synchronize its TSF timer when determining that the TIM field does not match and entering the doze state, since the STA updates the TSF timer only when the difference between its TSF timer and the TSF timer of the AP is smaller than the preset threshold value, it may insure that its TSF timers and the TSF timer of the AP are roughly the same and avoids the situation that the STA has not entered the awake state when the AP transmits the beacon frame, resulting in the inability to receive the beacon frame. That is, according to the example of FIG. 7, since the STA may synchronize its TSF timer with the AP correctly without confirming the condition of the FCS field, the STA may enter the awake state from the doze state at the right time to prepare to receive the beacon frame, so as to avoid entering the awake state too early and causing extra power consumption, and avoid entering the awake state too late to receive beacon frames.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A wireless communication device, comprising:
a radio frequency (RF) circuit, configured to receive a packet transmitted from an access point (AP) to generate an RF signal and convert the RF signal into a baseband signal;
a baseband circuit, coupled to the RF circuit, and configured to decode the baseband signal to obtain bit data; and
a media access control (MAC) circuit, coupled to the baseband circuit, and configured to parse the bit data to obtain information of a specific field in the packet, and stop receiving the packet in response to determining that the information of the specific field does not match the wireless communication device.

2. The wireless communication device of claim 1, wherein that the information of the specific field does not match the wireless communication device is that a destination MAC address of a MAC header field of the packet does not match the wireless communication device.

3. The wireless communication device of claim 2, wherein that the destination MAC address does not match the wireless communication device is that the destination MAC address does not match a MAC address of the wireless communication device.

4. The wireless communication device of claim 2, wherein the MAC circuit is configured to send a reset signal to the baseband circuit in response to the destination MAC address does not match the wireless communication device, and the baseband circuit is configured to reset its receiving function according to the reset signal.

5. The wireless communication device of claim 1, further comprising:
a wireless local area network (WLAN) processor, coupled to the MAC circuit;
wherein the packet is a beacon frame, and the MAC circuit is configured to send a trigger signal to the WLAN processor in response to determining that the information of the specific field does not match the wireless communication device, and the WLAN processor is configured to send an turn-off signal to the RF circuit to turn off the RF circuit.

6. The wireless communication device of claim 5, wherein the WLAN processor is further configured to send a reset signal to the baseband circuit according to the trigger signal to reset the baseband circuit.

7. The wireless communication device of claim 5, wherein the specific field is a mandatory field or an optional field located in a frame body of the beacon frame.

8. The wireless communication device of claim 7, wherein the specific field is a traffic indication map (TIM) field.

9. The wireless communication device of claim 5, wherein the specific field is located after a timestamp field of the beacon frame.

10. The wireless communication device of claim 9, wherein the MAC circuit comprises a station timing synchronization function timer (STA TSF timer), and the MAC circuit performs timing synchronization on the STA TSF timer with the AP by using information of the timestamp field.

11. The wireless communication device of claim 9, wherein the MAC circuit comprises a station timing synchronization function timer (STA TSF timer), and the MAC circuit is configured to calculate an AP timing synchronization function timer (AP TSF timer) of the AP according to information of the timestamp field and compare the AP TSF timer with the STA TSF timer;
wherein in response to determining that a difference between the AP TSF timer and the STA TSF timer is smaller than a preset threshold value, the MAC circuit performs timing synchronization on the STA TSF timer with the AP by using the information of the timestamp field.

12. A packet reception control method performed by a wireless communication device, the packet reception control method comprising:
performing address search on a packet to obtain a destination media access control (MAC) address of a MAC header in the packet at a start of receiving the packet transmitted from an access point (AP);
determining whether the destination MAC address matches the wireless communication device; and
resetting a receiving function of a baseband circuit of the wireless communication device to stop receiving the packet in response to determining that the destination MAC address does not match the wireless communication device.

13. The packet reception control method of claim 12, wherein that the destination MAC address does not match the wireless communication device is that the destination MAC address does not match a MAC address of the wireless communication device.

14. A packet reception control method performed by a wireless communication device, the packet reception control method comprising:
parsing a beacon frame to obtain information of a specific field in the beacon frame at a start of receiving the beacon frame transmitted from an access point (AP);
determining whether the information matches the wireless communication device; and
turning off a radio frequency (RF) circuit of the wireless communication device to stop receiving the beacon frame in response to determining that the information of the specific field does not match the wireless communication device.

15. The packet reception control method of claim 14, further comprising:
resetting a baseband circuit of the wireless communication device in response to determining that the information of the specific field does not match the wireless communication device.

16. The packet reception control method of claim 14, wherein the specific field is a mandatory field or an optional field located in a frame body of the beacon frame.

17. The packet reception control method of claim 16, wherein the specific field is a traffic indication map field.

18. The packet reception control method of claim 14, wherein the specific field is located after a timestamp field of the beacon frame.

19. The packet reception control method of claim 18, further comprising:
performing timing synchronization on a station timing synchronization function timer (STA TSF timer) with the AP by using information of the timestamp field.

20. The packet reception control method of claim 18, further comprising:
calculating an access point timing synchronization function timer (AP TSF timer) of the access point according to information of the timestamp field, and comparing the AP TSF timer with a station timing synchronization function timer (STA TSF timer); and
performing timing synchronization on the STA TSF timer of the wireless communication device with the AP by using the information of the timestamp field in response to determining that a difference between the AP TSF timer and the STA TSF timer is smaller than a preset threshold value.
